(19) United States
(12) Patent Application Publication
(10) Pub. No.: US 2005/0118957 A1
(43) Pub. Date: Jun. 2, 2005

(54) Testing mobile telephone terminals

(76) Inventor: Gregory Thomas Flitton, Bedfordshire (GB)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/506,370

(22) PCT Filed: Mar. 5, 2003
(86) PCT No.: PCT/GB03/00925

(30) Foreign Application Priority Data
Mar. 6, 2002 (GB) 0205312.2

(51) Int. Cl. H04B 17/00

(52) U.S. Cl. 455/67.11

(57) ABSTRACT

A mobile telephone terminal is tested by a test set transmitting to the terminal on a downlink a predetermined data pattern which it recognises and which prompts it to transmit an access request on an uplink. The access request is analysed by the test set to assess the performance of the terminal without the test set otherwise responding to the access request from the terminal. Multiple different data patterns may be used such that each prompt the terminal to transmit an access request to a different power level and/or specify a different maximum number of times the terminal should send an access request if it receives a response to none of them. The predetermined data pattern may be transmitted multiple times at different power levels and the response of the terminal analysed to determine a threshold at which it fails to transmit an access request.

### TECHNICAL FIELD

This invention relates to a method and apparatus for testing a mobile telephone terminal.

Known mobile terminal testers implement most of the communications protocol that a base station would use to communicate with the terminal, and interact with the terminal so as to measure its performance, for example, in terms of bit error rate and modulation quality. These testers are therefore relatively complicated both in terms of their hardware and software.

An object of the invention therefore is to provide a simplified method and apparatus for testing mobile telephone terminals.

### DISCLOSURE OF THE INVENTION

This is achieved according to the present invention by using a predetermined transmitted data pattern to trigger a response, preferably, an access request, from the terminal, and analysing the response to assess the performance of the terminal without responding to the terminal. The test apparatus does not therefore need to incorporate the associated hardware or software.

The invention will now be described by way of example with reference to the accompanying drawings, in which:

### DESCRIPTION OF THE DRAWINGS

FIG. 1 illustrates a conventional mobile ratio test set;

FIG. 2 illustrates a test set according to the invention; and

FIG. 3 illustrates an alternative embodiment of the invention.

### EMBODIMENTS OF THE INVENTION

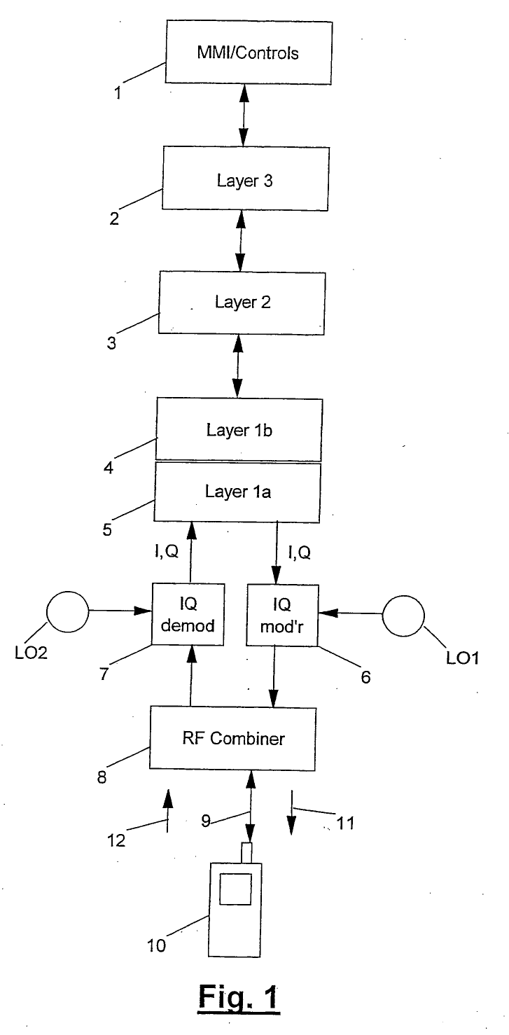

The architecture required for a conventional mobile radio test set, as illustrated in FIG. 1, comprises the following:

1. The MMI at the top of the tree: This usually includes some form of display to inform the user of the current instrument and test status. Keys allow the user to implement the chosen test.

2. Layer 3 protocol: This layer forms messages for the mobile and interprets messages from the mobile.

3. Layer 2 protocol: This layer's job is to ensure reliable transmission and reception of messages from/to Layer 3. For example, when sending a message to the mobile a response is usually made. If Layer 2 does not hear this response it will retransmit the message, on the assumption that the original transmission was not successful.

4. Layer 1b protocol: A subset of Layer 1. On the downlink this layer takes the Layer 2 blocks and applies channel encoding to aid successful transmission on the air interface. On the uplink the reverse happens and channel decoding is used to reveal the Layer 2 message from the mobile.

5. Layer 1a protocol (a subset of Layer 1): On the downlink this layer takes the binary information from Layer 1b and modulates it to give baseband I and Q samples. For the uplink this layer receives IQ samples and demodulates them back to binary values.

6. IQ modulator: On the downlink this takes the baseband IQ generated by Layer 1 and forms a signal at the correct carrier frequency using a local oscillator L01.

7. IQ demodulator: The reverse of the IQ modulator—it takes the modulated carrier and derives IQ at baseband using a local oscillator L02.

8. RF combiner where RF transmit/receive paths are combined into a single connection 9 of the antenna of the mobile telephone.

When a mobile 10 is first connected to the test set, there needs to be a signal that it can recognise. For GSM this takes the form of the Broadcast Control Channel (BCCH) in the downlink 11. There are a number of constituent elements to this channel:
(a) Frequency Control Channel (FCCH)
(b) Synchronisation Channel (SCH)
(c) System Information Messages

The mobile 10 uses the FCCH and SCH to synchronise to the test set emulation of a basestation, allowing it to demodulate and interpret the System Information Messages. Once it has done this, it may attempt to register with the test set. This registration process is initiated by the mobile 10 when it sends an Access burst on the Random Access Channel on the uplink 12. The test set demodulates the Access burst and responds. A brief series of messages pass between the test set and mobile as they exchange and verify system information.

Once a mobile 10 is registered, it is then possible to initiate a call to/from the mobile which will allow parametric tests of the mobile's transmitter and receiver.

The need to interact in real-time with the mobile leads to a complicated software/hardware architecture.

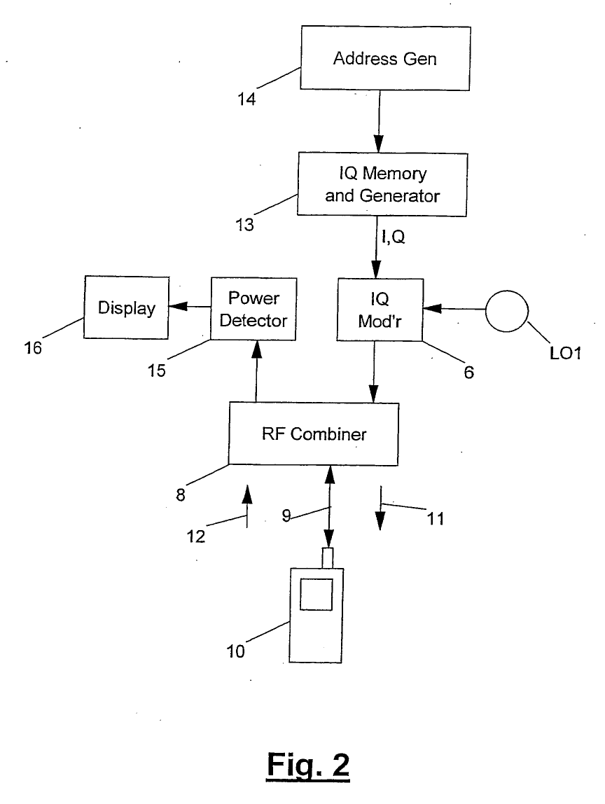

The invention simplifies the test set architecture by appreciating that a considerable amount of testing can be done by simply getting the mobile 10 to send an Access burst on the Random Access Channel. The invention achieves this with the architecture as illustrated in FIG. 2.

The IQ modulator 6 remains with its associated Local Oscillator (LO1), but the IQ data applied to it is no longer coming from a conventional Layer 1, 2, 3 architecture. Instead, a fixed Broadcast Control Channel is stored in a memory 13 as IQ samples. These are clocked out by an address generator 14 and applied to the IQ modulator 6.

Alternatively, the predetermined pattern may be generated using a subset of the protocol stack 2 to 5, for example, stored data symbols may be processed by a baseband modulator, which is a subset of Layer 1a, before being applied to the IQ modulator 6.

The mobile 10 responds to the fixed BCCH by sending an Access burst but it does not get a reply. The test set uses a power detector 15 to determine whether the mobile makes a transmission and this may be indicated to the user on a display 16. The power detector 15 may simply determine whether or not the transmission power is above a threshold level or may determine the actual transmission power level and report this to the display 16.

Alternatively, the access burst may be captured by a radio frequency receiver and analysed. The analysis may determine modulation quality, such as vector value, and report this or a comparison with allowable limits; or the analysis may determine spectral characteristics, such as adjacent channel power, occupied bandwidth and spurious signals, and report this or the comparison with allowable limits; or the analysis may determine the power envelope against time and compare this with a mask defining upper and lower allowable limits.

When the mobile 10 fails to get a reply to its Access burst it will try again a number of times, before searching for another signal.

The information in the stored BCCH tells the mobile the power level at which to transmit its Access burst, and the number of burst retries to perform So, a number of different BCCH can be stored and selected to test the mobile's power level control.

Placing an attenuator in the downlink would vary the output level from the test set to the mobile. This allows measure of sensitivity—slowly lowering the output power until the mobile no longer transmits Access bursts.

The test set may be connected directly to an antenna connector on the mobile phone 10 using a cable 9, as in the prior art of FIG. 1.

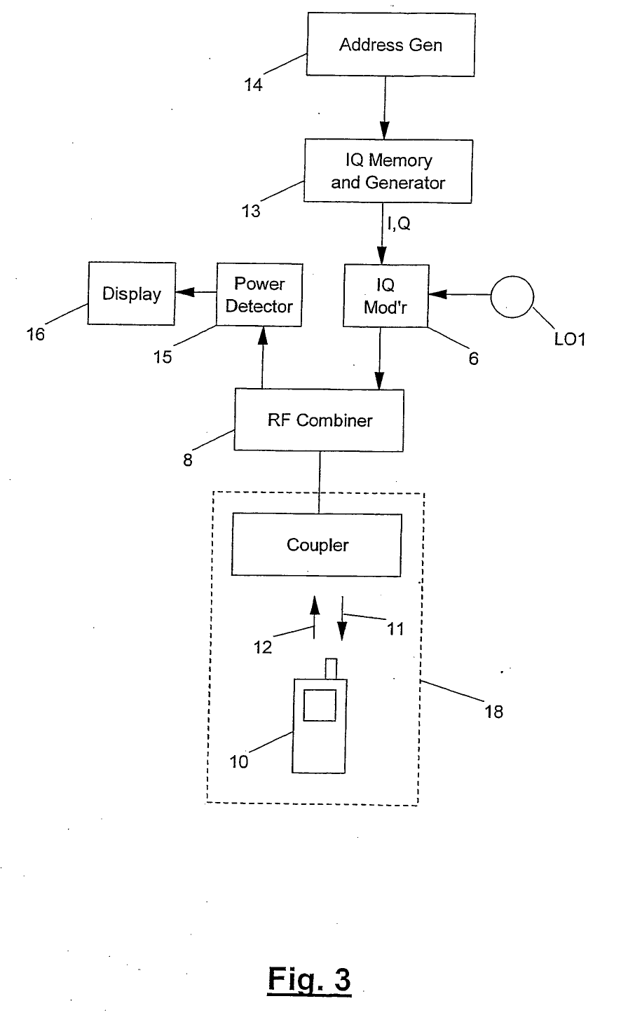

An alternative option, rather than cable connection 9 between the test set and the mobile, is to use a coupler 17, as illustrated in FIG. 3.

The coupler 17 makes a connection to the mobile 10 over the air interface rather than through a piece of cable. As such, the coupler 17 and mobile 10 may need to be screened from other signals as shown by screening 18 in FIG. 3. This makes sure that the mobile can only hear the test set signal. This approach then allows the test set to verify that the mobile's antenna is functioning correctly.

Thus, comparing the invention with the conventional test sets, the use of a stored downlink data pattern (BCCH) instead of a complete protocol stack, requires a lot less software development and does not require the complex signal processing hardware of conventional test sets.

The test set according to the invention is simpler, cheaper and more robust which makes it suitable for widespread use, for example, in retail outlets which sell mobile telephones. The retail outlets can then check a mobile to see if it is faulty before returning it to a more expensive repair centre.

The invention has been described above with reference GSM, but there are no reasons why the invention is not applicable to other systems such as Wideband CDMA.

1. A method of testing a mobile telephone terminal comprising the steps of:
transmitting to the terminal on a downlink a predetermined data pattern which the terminal will recognize and which will prompt the terminal to transmit an access request on an uplink, and
receiving the access request and analyzing the access request to assess the performance of the terminal without responding to the terminal.

2. A method as claimed in claim 1 in which multiple predetermined data patterns are provided for testing the terminal under different operating conditions, each data pattern prompting a different response from the terminal in transmitting an access request.

3. A method as claimed in claim 2 in which said multiple predetermined data patterns are such that they each prompt the terminal to transmit an access request at a different power level.

4. A method as claimed in claim 2 in which said multiple predetermined data patterns are such that they each specify a different maximum number of times the terminal should send an access request if the terminal receives a response to none of them.

5. A method as claimed in claim 1 in which said predetermined data pattern is transmitted multiple times at different power levels and the response of the terminal is analyzed to determine a threshold at which the terminal fails to transmit an access request.

6. A method as claimed in claim 1 in which said predetermined data pattern is transmitted to the terminal on a cable connection.

7. A method as claimed in claim 1 in which said predetermined data pattern is transmitted to the terminal over an air interface.

8. A method as claimed in claim 7 in which the air interface is screened from other signals.

9. A method as claimed in claim 1 in which the access request is analyzed by a power measurement.

10. A method as claimed in claim 1 in which the access request is analyzed by a modulation quality measurement.

11. Test apparatus for testing a mobile telephone terminal, the test apparatus being structured and arranged to transmit a predetermined data pattern on a downlink to prompt a response from the terminal in the form of an access request on an uplink, the test apparatus being structured and arranged to analyze the access request and produce a test result without further responding to the terminal.

12. Test apparatus as claimed in claim 11 which generates multiple predetermined data patterns for testing the terminal under different operating conditions of transmission power level and/or maximum number of access requests to be transmitted if there is no response to any of them.

13. Test apparatus as claimed in claim 11 which is adapted to vary the power level at which the test apparatus transmits said predetermined data pattern and to analyze the response to each from the terminal.

14. Test apparatus as claimed in claim 11 which is connected to the terminal to transmit said predetermined data pattern either by a cable connection or an air interface.

15. Test apparatus as claimed in claim 11 which is adapted to analyze the access request by making a power measurement.

16. Test apparatus as claimed in claim 11 which is adapted to analyze the access request by making a modulation quality measurement.

17. Test apparatus for testing a mobile telephone terminal, the test apparatus comprising a memory to store a predetermined data pattern and a transmitter to transmit said predetermined data pattern on a downlink to said mobile telephone terminal in order to prompt a response from said mobile telephone terminal in the form of an access request on an uplink to the test apparatus, and a processor to analyze said access request and produce a test result without responding to the access request on said downlink.
